(19) United States
(12) Patent Application Publication
(10) Pub. No.: US 2010/0021626 A1
(43) Pub. Date: Jan. 28, 2010

(54) METHOD OF FABRICATING RRAM

(76) Inventors: Chun-I Hsieh, Hsinchu City (TW); Chang-Rong Wu, Taipei County (TW); Shih-Shu Tsai, Taoyuan County (TW); Tsai-Yu Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/242,946

(22) Filed: Oct. 1, 2008

(30) Foreign Application Priority Data
Jul. 23, 2008 (TW) 097127944

(51) Int. Cl. B05D 5/12

(52) U.S. Cl. 427/77

(57) ABSTRACT

A method of fabricating a RRAM includes: forming a bottom electrode; forming a first metal layer, a first metal oxide layer, and a second metal layer on the bottom electrode in sequence; performing an RTO process followed by a top electrode formation; oxidizing the first metal layer to a second metal oxide layer comprising a second oxygen content; and oxidizing the second metal layer to a third metal oxide layer comprising a third oxygen content; wherein the first metal oxide layer has a first oxygen content after the RTO process is performed, the third oxygen content being higher than the first oxygen content and the first oxygen content being higher than the second oxygen content.

### BACKGROUND OF THE INVENTION

1. Field of the Invention

The present invention relates to a method of fabricating a RRAM, and more particularly, to a RRAM fabricating method which shortens the production time and maintains the reliability of the RRAM.

2. Description of the Prior Art

Resistive random access memory (RRAM) is a novel memory structure created in the semi-conductive field. A RRAM stores data by using the variable resistance characteristic of a metal oxide layer. Generally speaking, the resistance value of the metal oxide layer used in RRAM varies with voltage.

FIG. 1 shows a side view of a RRAM according to the prior art. As shown in FIG. 1, a RRAM 10 includes a bottom electrode 12, a resistive layer 14 and a top electrode 20. The resistive layer 14 is made of a kind of metal oxide. To make the resistive layer 14 become resistance variable, the RRAM 10 goes through a forming process by applying a gradually increasing voltage to the top electrode 20 and the bottom electrode 12, and then the current between the bottom electrode 12, the resistive layer 14 and the top electrode 20 is raised to a compliance voltage. In this way, the quality of the resistive layer 14 becomes non-uniform. After the forming process, the upper part of the resistive layer 14 will have less defects than the lower part of the resistive layer 14. Based on the quantity of defects, the resistive layer 14 can be further divided into a forming layer 16 and an operation layer 18. The forming layer 16 has more defects than those of the operation layer 18. When applying external voltage to the RRAM 10, current filament 22, 24 may occur in the forming layer 16 and the operation layer 18 respectively. The different defect densities in the forming layer 16 and the operation layer 18 show that the density of the current filament 22 in the forming layer 16 is denser than that of the current filament 24 in the operation layer 18. During operation, the density of the current filament 24 will change with the external voltage while the density of the current filament 22 is almost fixed. In this way, the resistive layer 14 can offer a variable resistance.

The forming process mentioned above is highly complicated and time-consuming. To speed up the forming process, conventional methods have tried to increase the external voltage in order to shorten the forming time. However, the quality of the forming layer 16 and the operation layer 18 will be damaged, causing the forming layer 16 and the operation layer 18 to become unstable during operation.

### SUMMARY OF THE INVENTION

Therefore, a novel method of forming a RRAM is provided in the present invention to simplify the fabricating steps and shorten the fabricating time. Moreover, a high quality operation layer can be obtained.

According to a preferred embodiment, a method of forming a resistive random access memory (RRAM) includes first forming a bottom electrode. After that, a first metal layer is formed on the bottom electrode. Subsequently, a first metal oxide layer is formed on the first metal layer. Then, a second metal layer is formed on the first metal oxide layer. Next, an oxidation process is performed to oxidize the first metal layer to a second metal oxide layer, and to oxidize the second metal layer to a third metal oxide layer, wherein after the oxidation process the first metal oxide layer comprises a first oxygen content, the second metal oxide layer comprises a second oxygen content, and the third metal oxide layer comprises a third oxygen content, wherein the third oxygen content is higher than the first oxygen content, and the first oxygen content is higher than the second oxygen content. Finally, a top electrode is formed on the third metal oxide layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a side view of an RRAM according to the prior art.

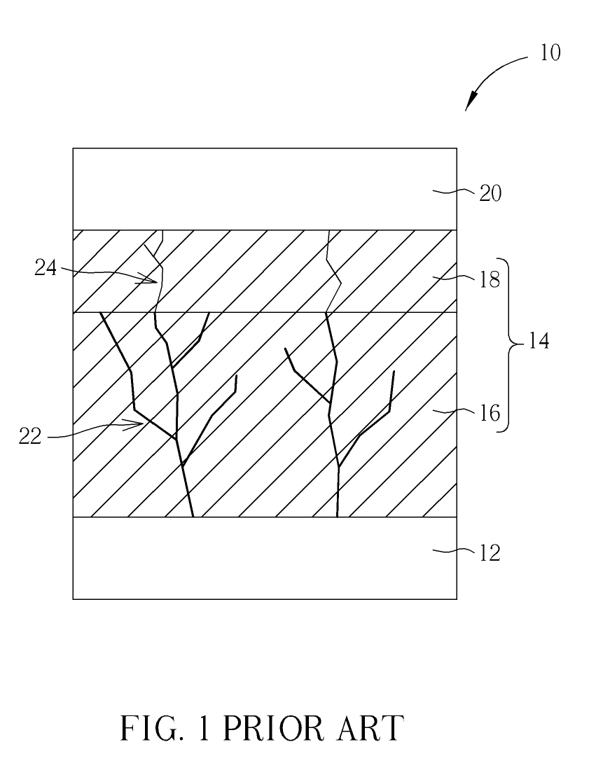

FIG. 2a to FIG. 2b depict a method of forming a RRAM according to the present invention.

### DETAILED DESCRIPTION

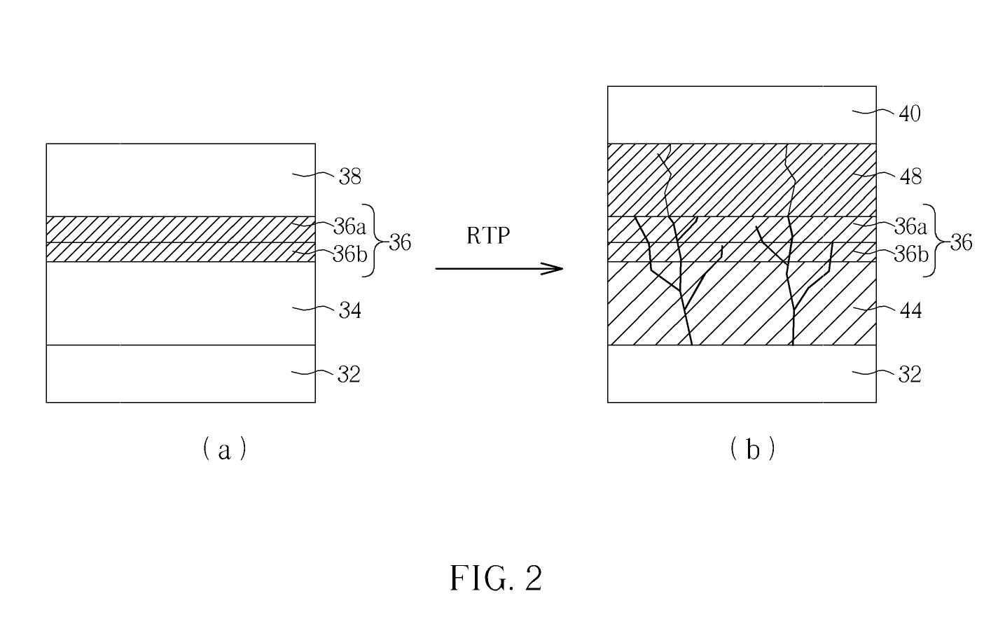

FIG. 2a to FIG. 2b depict a method of forming a RRAM according to the present invention. As shown in FIG. 2a, first, a bottom electrode 32 is formed. After that, a first metal layer 34 is formed on the bottom electrode 32. Subsequently, a first metal oxide layer 36 is formed on the first metal layer 34. Then, a second metal layer 38 is formed on the first metal oxide layer 36. The first metal oxide layer 36 can be formed by a single metal stack structure or a stack structure comprising at least two different metal oxides, 36a, 36b. The material for making the bottom electrode 32 is selected from the group consisting of Pt, AlCu, TiN, Au, Ti, Ta, TaN, W, WN and Cu. The material for making the first metal layer 34 and the second metal layer 38 are selected from the group consisting of Ni, Ti, Hf, Zr, Zn, W, Al, Ta, Mo, and Cu. According to a preferred embodiment of the present invention, the material utilized to form the first metal layer 34 and the second metal layer 38 are preferably a high reactive metal, such as Pt. Moreover, the material for the first metal oxide layer 36 can be selected from the group consisting of NiO, TiO, HfO, ZrO, ZnO, WO₃, Al₂O₃, TaO, MoO and CuO. The bottom electrode 32, the first metal layer 34 and the second metal layer 38 can be fabricated by a sputtering process or an atomic layer deposition (ALD) process. The first metal oxide layer 36 can be fabricated by an ALD process or a chemical vapor deposition (CVD) process.

Then an oxidation process such as a rapid thermal oxidation process is performed. The rapid thermal oxidation process is performed at an operating temperature higher than 800° C. for a time period in a range from about 15 seconds to about 60 seconds. As shown in FIG. 2b, after the oxidation process, the first metal layer 34 is oxidized to a second metal oxide layer 44, and the second metal layer 38 is oxidized to a third metal oxide layer 48. Therefore, the first metal oxide layer 36 has a first oxygen content, the second metal oxide layer 44 has a second oxygen content, and the third metal oxide layer 48 has a third oxygen content, wherein the third oxygen content is higher than the first oxygen content, and the first oxygen content is higher than the second oxygen content. Finally, a top electrode 40 is formed on the third metal oxide layer 48. The method and the material for forming the top electrode 40 can be the same as that of forming the bottom electrode 32, and details are therefore omitted here. At this point, the RRAM of the present invention is finished.

During the oxidation process, oxygen atoms in the second metal layer 38 are blocked by the first metal oxide layer 36, so oxygen atoms are unable to penetrate the underlying layer such as the first metal oxide layer 36. Therefore, oxygen atoms remain in the second metal layer 38 for oxidizing the second metal layer 38 to the third metal oxide layer 48 provided with a third oxygen content. During the same oxidation process, oxygen atoms in the first metal oxide layer 36 diffuse to the underlying layer such as the first metal layer 34 to oxidize the first metal layer 34 to the second metal oxide layer 44 having therein a second oxygen content. Because the oxygen atoms in the second metal oxide layer 44 primarily come from the diffused oxygen atoms in the first metal oxide layer 36, the second oxygen content is lower than the third oxygen content. Generally speaking, a metal oxide having high oxygen content has less oxygen vacancy. Therefore, the metal oxide has a better quality, whereas a metal oxide having low oxygen content has low quality. Since the third oxygen content is higher than that of the first oxygen content, and the first oxygen content is higher than that of the second oxygen content, the third metal oxide layer 48 has a quality better than that of the first metal oxide layer 36 and the quality of the first metal oxide layer 36 is better than that of the second metal oxide layer 44.

During the process, the first metal oxide layer 36 and the second metal oxide layer 44 have high oxygen vacancy, so they can provide enough current filament to serve as the forming layer, and the filament is maintained substantially fixed. The third metal oxide layer 48 has a current filament that can change by providing various external voltage in virtue of less oxygen vacancy to serves as the operation layer.

Furthermore, an inter layer (not shown) such as TiN can be optionally formed between the second metal oxide layer 44 and the bottom electrode 32. That is, in FIG. 2a, an inter layer (not shown) can be optionally formed on the bottom electrode 32 before the first metal layer 34 is formed. The inter layer is used to improve the affinity between the bottom electrode 32 and the second metal oxide layer 44.

Moreover, the first metal oxide layer 36 has a thickness smaller than that of the second metal oxide layer 44 and of the third metal oxide layer 48. According to a preferred embodiment of the present invention, the thickness of the first metal oxide layer 36 is smaller than 10 nm, the thickness of the second metal oxide layer 44 is between 10 nm to 20 nm and the thickness of the third metal oxide layer 48 is between 10 nm to 20 nm.

Compared to the conventional method, the method provided in the present invention can shorten the fabricating time, while the operation layer can still maintain good quality. It is noteworthy that the forming process is replaced by the novel fabricating method of the present invention and the fabricating method is simplified therein.

Those skilled in the art will readily observe that numerous modifications and alterations of the device and method may be made while retaining the teachings of the invention.

What is claimed is:

1. A method of forming a resistive random access memory (RRAM), comprising the steps of:
forming a bottom electrode;
forming a first metal layer on the bottom electrode;
forming a first metal oxide layer on the first metal layer;
forming a second metal layer on the first metal oxide layer;
oxidizing the first metal layer to a second metal oxide layer, and the second metal layer to a third metal oxide layer, wherein, after the oxidation process, the first metal oxide layer comprises a first oxygen content, the second metal oxide layer comprises a second oxygen content, and the third metal oxide layer comprises a third oxygen content, wherein the third oxygen content is higher than the first oxygen content, and the first oxygen content is higher than the second oxygen content; and
forming a top electrode on the third metal oxide layer.

2. The method of claim 1, wherein the first metal oxide layer is a stack structure comprising at least two different metal oxides.

3. The method of claim 1, wherein the first metal oxide layer is formed by a material selected from the group consisting essentially of NiO, TiO, HfO, ZrO, ZnO, WO₃, Al₂O₃, TaO, MoO and CuO.

4. The method of claim 1, wherein the first metal layer and the second metal layer are made of a material selected from the group consisting essentially of Ni, Ti, Hf, Zr, Zn, W, Al, Ta, Mo, and Cu.

5. The method of claim 1, wherein the top electrode and the bottom electrode are made of a material selected from the group consisting essentially of Pt, AlCu, TiN, Au, Ti, Ta, TaN, W, WN and Cu.

6. The method of claim 1, wherein the oxidation process is a rapid thermal oxidation process.

7. The method of claim 6, wherein the rapid thermal oxidation process is performed at an operating temperature higher than 800° C.

8. The method of claim 7, wherein the operating temperature is processed for a time period ranging from 15 seconds to 60 seconds.

9. The method of claim 1, wherein the first metal oxide layer has a thickness smaller than that of the second metal oxide layer and that of the third metal oxide layer.

10. The method of claim 1, wherein the first metal oxide layer has a thickness smaller than 10 nm, the second metal oxide layer has a thickness ranging from 10 nm to 20 nm and the third metal oxide layer has a thickness between 10 nm and 20 nm.
